(19) United States
(12) Patent Application Publication
(10) Pub. No.: US 2003/0004814 A1
(43) Pub. Date: Jan. 2, 2003

(54) Procedure and arrangement for supervision of a store- room and delivery of merchandise

(76) Inventor: Rutger Roseen, Stockholm (SE)

Correspondence Address: PEARNE & GORDON LLP, 526 SUPERIOR AVENUE EAST, SUITE 1200, CLEVELAND, OH, 44114-1484, US

(21) Appl. No.: 10/070,061

(22) PCT Filed: Jun. 27, 2001
(86) PCT No.: PCT/SE01/01475

(30) Foreign Application Priority Data
Jun. 28, 2000 (SE) 0002435-6

(51) Int. Cl. G06F 17/60

(52) U.S. Cl. 705/22

(57) ABSTRACT

The invention concerns a procedure and an arrangement for attendance-free retail trade. The arrangement comprises a space (2) closed by a door (4) and provided for the exposure of goods (6). Within the space cameras (7) are present for registering of take-outs, and these cameras send the pictures taken to an image processing unit (9), which supplies inventory lists to a central computer (10). Unlocking of the door (4) can take place through cellphone communication with the central computer, or by means of a card provided with a magnetic strip, which is read in a reader equipped with a keypad (12)

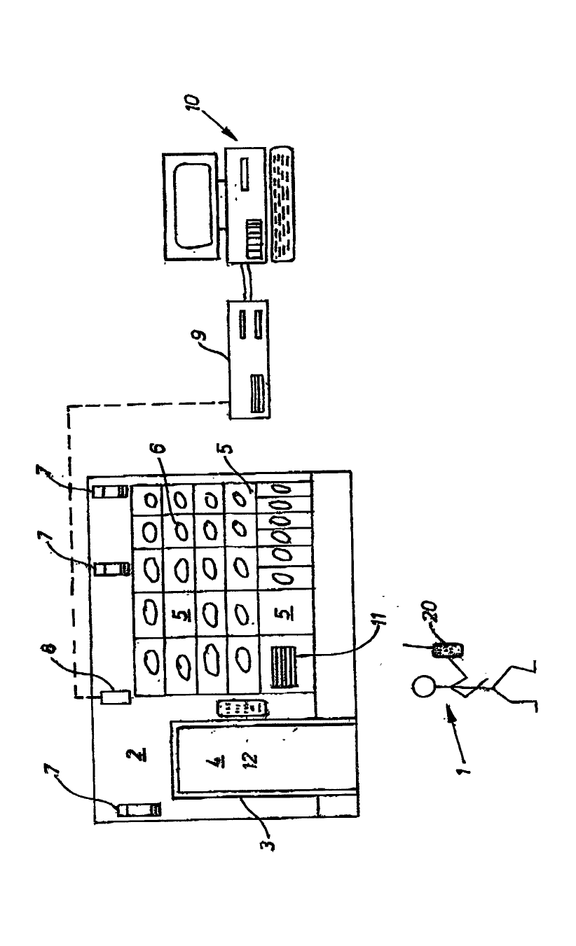

The present invention refers to a procedure for unattended delivery of merchandise from a locked space, and supervision of the levels of stock therein, and also an arrangement to accomplish the procedure.

In shops and other sales places, much manual work occure in the chain of goods handling. The articles shall usually be ordered from a wholesale dealer, be received and frequently stored to be later brought into the sales premises, there being placed on shelves.

Even if the customers gather desired articles for their purchases, and bring these to an exit cash-point, an additional manual registering of the articles should take place and payment be collected. Finally, before bringing the goods home the customer has himself to pack these in bags and the like.

Depending on limitation of working hours and stipulations in wages pay agreements on increased payment certain hours around the clock, the opening hours of shops must be restricted to those hours of a day, when most customers have a possibility to visit the place of purchase. It is requested of those working essentially during the opening hours of the shops that they carefully plan their purchases. This is not in conformity with modern peoples' lifestyle. Besides, from the viewpoint of the shopkeeper, the number of impulse-buy will be reduced, and he will loose a certain sale.

Even though the need for shops open around the clock don't exists, some people feel that such a service should be offered. So has also taken place since long ago; for sweets since the interwar period, for cigarettes since early 1950s , both phenomena in the shape of slot-machines with one-article-pigeon-holes, and since late 1950s in the form of article-carousels for wrapped eatables. Those two types of sales automatic machines have been equipped with slots, first for only one denomination of coin represented in each column of compartments, by and by with arrangements for rendering up change, which need was stressed by the first vending machines where bank-notes could constitute means of payment.

A modern type of automatic delivering machines, where the payment takes place by means of a plastic card, including a magnetic strip, is the machines giving out bank-notes, e.g. those of the trade-mark BANKOMAT.

Known are also since many years vending machines for non-bottled or non-packed warm or cold beverages. Those are equipped with a slot for coins or jettons, and alter payment has been made therethrough, the choice of drink and desired accompaniments can be made by way of push-bottons along a menu, e.g. coffee with cream and sugar. Thereupon, in a niche the machine gives out a cup, which will be filled with the ordered drink.

Common for the vending machines known are that they operate totally unattended. Depending on the frequency of use, the machines might need refill one or several times per day. There exists a limitation in the line of articles, which can be sold in this known unattended way. Of course, the compartments can be enlarged to possibly house articles bigger in volume, but hithereto several reasons have curbed such a development. One hindrance has perhaps been the mode of payment for costly articles. Besides, the prices are fixed, and the known system does not offer any possibility for quantity discount or purchase loyality reward.

The present invention is based on the wish to supply the most varying types of articles, around the clock, without manual service. To attain the aim to offer to customer a procedure, whereby this type of sale can be accomplished, an arrangement has been invented. In this connection, as a starting-point, the learning has been used, which could be gathered from the Swedish patent application No. 9900582-9.

An arrangement for sale or delivery of goods is composed of a space furnished with a lockable door or scuttle, e.g. in the shape of a show-case hanging on a wall, a free-standing exhibition case, both with out or more sides of transparent material, or a separate room, preferably narrow. By preference, this space is divided into, or equipped with, a number of compartments or one-side boxes, one for each type of article offered for sale.

At show-cases or exhibition cases a scuttle is used, and the customer must stand outside the respective space, but with access to all compartments existing therein. In case of a room the customer can enter through a door, however, the intention is that only one person at a time should visit the room, possibly several in company, but with one person liable for later payment of the goods delivered.

The lockable door or scuttle is always kept locked. To get access to the interior of the space by opening the door or scuttle, one of following ways has to be used.

In its simpliest accomplishment the door is locked by means of a code lock, which can be adequate in a block of flats, wherein one common room is set aside for the inhabitants and into which delivery-men can deposit goods sent by mail or parcel service such that has been ordered e.g. by way of Internet. To open the door to such a room, the tenants have to enter on a keypad first a common combination of digits, and then a personal code. The latter procedure is for identifying who has at every occation effected access to the rooms. The procedure for identification will by dealt with in the following.

In a second way of unlocking the door or scuttle, which is intended preferably for public use, a credit card is drawn through a card reader outside the saled premises, whereupon the PIN-code of the card is entered on a keypad, if necessary supplemented with a customer's code. A so called smart card, i.e. plastic card with a built-in chip, could be used instead of a credit card. The use of a customer's code is intended prevent abuse of a lost or stolen card.

A third way of unlocking the door takes place wit the aid of a cellphone. The procedure will then be as follows. The customer phones telephone number exposed in the sales space, and visible from outside. The call is directed to a central computer being part in the arrangement, and which either directly out of the number of the calling telephone identifies the customer, or after a request transcripted on the display of the telephone demands some form of access code, which the phoning person enters on the keypad of the telephone, whereupon the computer approves the customer. Acknowledgement can take place after a check on credit rating in a registry in the central computer, or via connection with the customer's bank.

After approval of the customer has been approved, which does'nt take more time than a couple of seconds, the customer gets an access code on the display of his telephone to enter on the keypad of the doorlock, or the lock is opened by the central computer.

Independent of the manner used to unlock the door to the sales room, concurrently with the opening of the door or scuttle a photograph is taken of the stock-in-trade by means of one or more digital cameras, and the pictures are transmitted to an image processing unit being part of the arrangement. In countries where it is not legally restricted, one camera can also take a picture of the customer.

When the customer has gathered the articles he wishes and left the sales space, and closed scuttle or door behind him (without giving any other person access to the sales space), the digital cameras take pictures of the stock-in-trade anew. This second set of pictures are sent to the processing unit of the arrangement for comparison with those earlier received pictures, which were taken at the customer's access to the sales space. The image processing unit gives two lists of stock to the cow computer, one based on the first sequence of pictures, and one based on the second sequence. The computer analyses the difference, consequently, which articles the customer has brought out of the sales space, and calculates the total cost from price-lists stored for these articles. When a cellphone is used, the cost is shown at the display thereof. At other procedures for access to the sales space, the cost can be shown on a display visible from outside the sales space. An invoice specifying the purchases will be sent to the customer later on.

In an unattended shop of the kind now invented, and in which very expensive articles are available, the customer's free way out of the shop might take place through a lock. In this the customer must wait while the central computer calculates the sum total of the prices of gathered articles. In case this sum exceeds the credit rating the customer has been entrusted, through an aperture arranged in the lock the customer has to return articles to such a value that the remaining value of the goods is below the credit limit. Not until that is done, the customer is afforded possibility to leave shop.

Of course, some kind of price-reader can be installed in the shop by means of which from time to time the customer can check the buying-sum reached.

A preferred embodiment of the arrangement according to the invention will be described in detail with reference to the annexed drawing which schematically shows the components forming integral parts of the invention, without any claim for being to scale.

A space giving a customer 1 possibility to purchase goods, without help of any shop assistant, has been designed as a narrow room 2 with one long side constituted by a shop-window, except for a door section 3 including a locked door 4. In the room 2 the long side opposite shop-window is substantially covered by pigeon-holes 5, in which various articles 6 are exposed.

Several cameras 7 of a digital type, e.g. such of CMOS-technology, are fixed in the room, and especially directed so as to cover together all pigeon-holes 5. The cameras take pictures, which are digitalised and sent via wireless communication to a transmitter 8 available in the room. Via wireless or permanent communication the transmitter 8 transfers camera information to an a processing unit 9. This unit converts the picture information into inventory lists, which are brought to a central computer 10 that might work in common for several shops of the kind invented.

When a person has been attracted to an article 5, visible through the shop-window, and has decided to buy it, he acts in the following way.

By means of a cellphone 20 the customer 1 phones the central computer 10 via a number exposed on a display 11 visible through the shop-window. The display might show additional information on the course of action how to get into the shop. When the customer has been indentified, e.g. by a customer code, the central computer makes a credit rating check in an internal registry, or checks a bank account the number of which has been submitted previously by the customer, or a credit card number entered on the keypad of the cellphone 20.

When the central computer 10 has established that the customer is entrusted credit rating, an access code is transmitted to the display of the cellphone 20, which code is valid one single time. The customer enters the code on a keypad 12 placed beside the door 4, whereupon the door can be opened. Normally, the customer alone enters the shop and the door is closed by a doorcloser of a kind commonly known.

Concurrently with the opening of the door, the cameras 7 take photographs of all the stock-in-trade present in the shop. In case the customer be accompanied, which is indicated to the system by the fact that the door 4 is open longer than necessary for a person normally to get in, the cameras 7 will take an additional picture. The person who has received to his cellphone an access code is responsible to the shopkeeper for the articles, which after the customers visit to the shop are registered as gathered from the pigeon-holes.

When the customer exits the room 2, and the door 4 has been locked, the cameras 7 take further pictures of all the remaining stock-in-trade. These digital pictures are sent by the transmitter 8 to the image processing unit 9, which converts the pictures to inventory list then transferred to the central computer 10. Since the computer has already received an inventory list after that the immediate preceding customer left the shop, and one list principally corresponding to said preceding customer list from the moment the present customer entered the room 2, the central computer 10 can establish the difference between the stock-in-trade as the customer entered the shop, and the stock according to the later list, at the customer 1 left the shop. The result represents the customer's purchase, and the central computer immediately calculates the purchase-sum, and information on this can be transferred to the display of the cellphone 20. Payments are then effected through an established system, e.g. deduction from the customer's bank account.

What has been described above might be regarded as pertaining to rarely bought commodities, purchased in single specimen. The invention is applicable to everyday commodities however, the only prerequisite is that they are prepacked. As a one and only example milk can be adduced to illustrate the functioning. Since decades, milk is sold in parallelpipedic carton packages, which can be stored on a sliding chute, emanating from a refrigerated stock-room behind the pigeon-hole wall. If the customer wishes to buy several packages of a certain sort of milk, such slide forward as the customer picks the package accessible at the end of the pigeon-hole 5. On a display beside the pigeon-hole 5 a counter shows the number of packages picked. This figure will be visible on the picture taken by the camera 7, as the customer leaves, and is thus included in the debiting document calculated by the central computer 10.

As regards staple commodities like coffee, which are substantially not temperature-sensitive, it is possible that such are brought into the room 2 on loading pallets. Based on the difference between pictures taken by the cameras 7 at the customer's entrance and his exit respectively, the central computer 10 can calculate the number of packages removed from a specific pallet.

The embodiment of the invention embracing a room 2, which the customer 1 can enter into, is of course the most favourable for sale of staple commodities, because it could easily be arranged required storage capacity in an adjacent room behind the pigeon-holes 5. If the architectural prerequisites are suitable and the premises are consistent in lay-out, the invention designed as a wall cupboard showcase can also be furnished with a rear store for automatic refilling of the pigeon-holes. It is more difficult, but not impossible, to organise a refill system for a free-standing display case. In case this is placed indoor with a cellar beneath, e.g in a shopping mall, it is possible to arrange an elevator device in a shaft centrally located in the display case, the elevator carrying a transferring arm robot, governed by the central computer instructing the refilling of the stock-in-trade.

Based on the bookkeeping in the central computer 10, all take-aways of goods from the shop, as well as all supplies to the shop, either the shop consists of the room 2 only, or there exits a stock-room behind, the remaining volume of goods are known at every occation. Following experience gained about the rate of turnover for different articles in a shop, desired order points can be programmed into the central computer 10. Out of these points replenishment deliveries can be organised.

During the customer's stay in the room 2, or access to the embodiment of the invention in the form of a show-case, at any time, randomly the cameras 7 can take pictures, whereby attempts to manipulate packages, and empty those of their content, can easily be revealed and related to a definite, identified customer.

When the invention is used as a delivery-room in a block of flats, the security would probably be adequate in that each inhabitant's access code and time of use have been registered in the central computer, and the computer also stores information on, which packages were in the room at the time of entrance of the person in queston, and which packages were left at the juncture the visitor left the room. Here would not any problems arise concerning integrity, but the cameras could be directed to take a photograph of everybody entering the room, and in the central computer the picture can be stored together with the point of time it was taken.

The access means smart card can be designed only to perform its function a certain number of times, or only at special occations of sales. Different cards can have different loyal-customer-discounts. Such discounts can also be stored in the central computer for customers with other means of access. Occasional offers can be advertised on the display in the shop.

The invention gives possibilities for remote-controlled change of prices, from the central computer, if electronic labels on the shelf-edges are used.

The invention can be varied in a multiplicity of ways within the frame set by the following claims. The limitation of articles marketable might lie in weight and size; the customer must be able to carry the article home. Otherwise the order for an article can take place after it has been looked at in a show-case, whereby directions on how to order are given on a display visible in the show-case. The customer might e.g. phone the central computer and follow the instructions by entering his order on the keypad of his telephone. Delivery takes place at a later time to the customer's door or, in a block of flats, to the delivery room for packages described above.

1. Procedure for supervision of a store-room and delivery of merchandise from a room sealed by means of a door or scuttle provided with a lock device, without direct assistance of any staff, characterized in that the locking device of the door (4) by means of a key, an electronically active contactor means or radio waves from a cellphone (20) is influenced to an open position, whereupon the space (2) becomes accessible for the person, who shall gather goods, that concurrently with the opening of the door stock-in-trade is photographed by one or more electronic cameras (7), and that when the door is shut after the take-out of the goods, the stock-in-trade is photographed anew.

2. Procedure according to claim 1, characterized in that the camera (7) digitalizes the pictures, and sends these to an image processing equipment (9), which converts the pictures to inventory lists, which are stored in a central computer (10).

3. Procedure according to claim 1 or 2, characterized in that the central computer (10) is called from the cellphone (20) and after identifying the cellphone the central computer submits a code which is indicated on the display of the phone and which can be entered on a key pad (12) in order to open the door (4).

4. Procedure according to claim 3, characterized in that after the door (4) has been locked the central computer (10) performs a comparison between the two inventory lists received from the image processing unit (9), based on pictures taken by the cameras (7) at the opening and closing of the door respectively, calculates the cost for the articles taken out, and transmits this value to be presented on the display of the cellphone.

5. Procedure according to claim 4, characterized in that the central computer (10) automatically prints out a specified invoice, which is sent to the person having gathered the goods.

6. Procedure according to claim 2, characterized in that the central computer (10) indicates when the quantity of a certain article in the stock is below a chosen order point.

7. Arrangement for sale or delivery of goods without assistance of any attendance staff, characterized by a space (2) provided with a locked door (4) and containing a stock-in-trade (6), one or more electronic cameras (7) fixed in the space, a lock for locking of the door operable by a key or electronically, an image processing unit (9) connected to the camera (7), and a central computer (10) for storing of data from the image processing unit (9) and for external communication, wherein at delivery of goods the lock of the door is effected to open position and concurrently with the opening of the door the stock-in trade is photographed by the cameras (7) and when the door is locked after the delivery the stock-in trade is again photographed.

8. Arrangement according to claim 7, characterized in that the space (2) is surrounded, wholly or partly, by transparent walls.

9. Arrangements according to claim 7 or 8, characterized in that the central computer (10) is equipped for two-way communication with cellphones.

10. Arrangements according to any of the claims 7 to 9, characterized in that the lock is designed as an electronically controlled code lock, operated by the central computer (10).

11. Arrangements according to any of the claims 7 to 9, characterized in that the lock is designed as an electronically controlled code lock operated by a magnetic strip of a credit card.

12. Arrangements according to any of the claims 7 to 9, characterized in that the lock is designed as an electronically controlled code lock operated by a so-called smart card.
